(19) United States
(12) Patent Application Publication
(10) Pub. No.: US 2024/0007894 A1
(43) Pub. Date: Jan. 4, 2024

(54) MULTI-LINK TRAFFIC INDICATION FOR MULTI-LINK DEVICE

(71) Applicant: Samsung Electronics Co., Ltd., Suwon-si (KR)

(72) Inventors: Vishnu Vardhan Ratnam, Plano, TX (US); Peshal Nayak, Plano, TX (US); Boon Loong Ng, Plano, TX (US); Rubayet Shafin, Allen, TX (US)

(21) Appl. No.: 18/338,250

(22) Filed: Jun. 20, 2023

Related U.S. Application Data
(60) Provisional application No. 63/357,996, filed on Jul. 1, 2022.
(60) Provisional application No. 63/388,547, filed on Jul. 12, 2022.
(60) Provisional application No. 63/398,771, filed on Aug. 17, 2022.

(51) Int. Cl. H04W 28/02

(52) U.S. Cl. CPC H04W 28/0252

(57) ABSTRACT

A wireless communication network includes an access point (AP) multi-link device (MLD) and a non-AP MLD. The AP MLD generates a traffic indication map (TIM) element that indicates pending buffered traffic for a plurality of non-AP MLDs associated with the AP MLD and selectively generate a multi-link traffic indication element that includes per-link traffic indication to retrieve buffered traffic for at least one non-AP MLD, based on determining whether all of the plurality of non-AP MLDs have default traffic identifier (TID)-to-link mapping and whether the AP MLD has buffered traffic with TIDs that are not mapped to all enabled links for the at least one non-AP MLD. The AP MLD transmits the beacon frame including the TIM element and the optional multi-link traffic indication element to the plurality of non-AP MLDs.

### CROSS-REFERENCE TO RELATED APPLICATIONS

This application claims the benefit of priority from U.S. Provisional Application No. 63/357,996, entitled “ENHANCEMENT FOR MULTI-LINK TRAFFIC INDICATION FOR A NONAP MLD,” filed Jul. 1, 2022; U.S. Provisional Application No. 63/388,547, entitled “MULTI-LINK TRAFFIC INDICATION,” filed Jul. 12, 2022; and U.S. Provisional Application No. 63/398,771, entitled “METHODS AND APPARATUS TO REDUCE SIZE OF MULTI-LINK TRAFFIC INDICATION FOR A NONAP MLD,” filed Aug. 17, 2022, all of which are incorporated herein by reference in their entirety.

### TECHNICAL FIELD

This disclosure relates generally to wireless communication, and more particularly to, for example, but not limited to, multi-link traffic indication for a multi-link device in a wireless communication system.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One embodiment of the present disclosure provides an access point (AP) multi-link device (MLD) associated with a wireless network. The AP MLD comprises at least two APs affiliated with the AP MLD and a processor coupled to the at least two APs. The processor is configured to generate a traffic indication map (TIM) element that indicates pending buffered traffic for a plurality of non-AP MLDs associated with the AP MLD. The processor is configured to selectively generate a multi-link traffic indication element that includes per-link traffic indication to retrieve buffered traffic for at least one non-AP MLD, based on determining whether all of the plurality of non-AP MLDs have default traffic identifier (TID)-to-link mapping and whether the AP MLD has buffered traffic with TIDs that are mapped to all enabled links for the at least one non-AP MLD. The processor is configured to generate the beacon frame including the TIM element and the multi-link traffic indication element that is selectively included. The processor is configured to transmit the beacon frame to the plurality of non-AP MLDs.

In some embodiments, the processor is configured to generate the multi-link traffic indication element when at least one of the associated non-AP MLDs has successfully negotiated a TID-to-link mapping with the AP MLD and the AP MLD has buffered traffic with TIDs that are not mapped to all enabled links for the at least one non-AP MLD.

In some embodiments, the processor is configured to generate the multi-link traffic indication element when the AP MLD intends to provide a link recommendation to retrieve buffered traffic to the at least one non-AP MLD.

In some embodiments, the processor is configured to refrain from generating the multi-link traffic indication element when the AP MLD does not intend to provide a link recommendation to retrieve buffered traffic to any of the associated non-AP MLDs and when the AP MLD does not have buffered traffic with TIDs that are mapped to only a subset of enabled links for any of the associated non-AP MLDs.

In some embodiments, the multi-link traffic indication element includes a recommendation field that indicates the at least one non-AP MLD for which the AP MLD provides the per-link traffic indication to retrieve buffered traffic. The per-link traffic indication includes a link recommendation or a traffic indication.

In some embodiments, the recommendation field includes a set of bits. Each bit corresponds to a respective one of associated non-AP MLDs and non-AP stations (STAs), starting from an offset number of a traffic indication virtual bitmap in the TIM element. Each bit indicates whether the AP MLD provides the per-link traffic indication for corresponding non-AP MLD or non-AP STA.

In some embodiments, the recommendation field includes a set of bits. Each bit corresponds to a respective one of associated non-AP MLDs and non-AP STAs that are indicated to have buffered traffic in a traffic indication virtual bitmap of the TIM element, starting from an offset number of the traffic indication virtual bitmap in the TIM element. Each bit indicates whether the AP MLD provides the per-link traffic indication for corresponding non-AP MLD or non-AP STA.

In some embodiments, the multi-link traffic indication element optionally includes the recommendation field, and the multi-link traffic indication element includes a recommendation present field that indicates whether the recommendation field is present in the multi-link traffic indication element.

In some embodiments, the multi-link traffic indication element includes one or more per-link traffic indication fields. Each field provides a link recommendation or a traffic indication for a respective one of the at least one non-AP MLD.

In some embodiments, the multi-link traffic indication element is included in a group-addressed frame and not associated with the TIM element, including a recommendation field that indicates the at least one non-AP MLD for which the AP MLD provides the per-link traffic indication to retrieve buffered traffic.

One embodiment of the present disclosure may provide a non-AP MLD associated with a wireless network. The non-AP MLD comprises at least two stations (STAs) affiliated with the non-AP MLD and a processor coupled to the at least two STAs. The processor is configured to receive, from an AP MLD associated with the non-AP MLD, a traffic indication map (TIM) element included in a beacon frame. The TIM element indicates pending buffered traffic for the non-AP MLD. The processor is configured to determine whether a multi-link traffic indication element is present in the beacon frame. The multi-link traffic indication element is selectively included in the beacon frame based on whether all of the plurality of non-AP MLDs associated with the AP MLD have default traffic identifier (TID)-to-link mapping and whether the AP MLD has buffered traffic with TIDs that are mapped to all enabled links for the associated non-AP MLDs. The processor is configured to determine whether a per-link traffic indication for the non-AP MLD is present in the multi-link traffic indication element when the multi-link traffic indication element is present, the per-link traffic indication providing a traffic indication or a link recommendation to retrieve buffered traffic for the non-AP MLD. The processor is configured to transmit, to the AP MLD, a trigger frame to retrieve buffered traffic via a link indicated in the per-link traffic indication when the per-link traffic indication for the non-AP MLD is present. The processor is configured to receive, from the AP MLD, buffered traffic via the link indicated in the per-link traffic indication.

In some embodiments, the multi-link traffic indication element is present in the beacon frame when at least one of the associated non-AP MLDs has successfully negotiated a TID-to-link mapping with the AP MLD and the AP MLD has buffered traffic with TIDs that are not mapped to all enabled links for the associated non-AP MLDs.

In some embodiments, the multi-link traffic element is present in the beacon frame when the AP MLD intends to provide a link recommendation to retrieve buffered traffic to at least one associated non-AP MLD.

In some embodiments, the multi-link traffic indication element is absent in the beacon frame when the AP MLD does not intend to provide a link recommendation to any of the associated non-AP MLDs and when the AP MLD does not have buffered traffic with TIDs that are mapped to only a subset of enabled links for any of the associated non-AP MLDs.

In some embodiments, the multi-link traffic indication element includes a recommendation field that indicates at least one non-AP MLD for which the AP MLD provides the per-link traffic indication. The processor is configured to determine whether the per-link traffic indication for the non-AP MLD is present in the multi-link traffic indication element, based on the recommendation field.

In some embodiments, the recommendation field includes a set of bits. Each bit corresponds to a respective one of associated non-AP MLDs and non-AP stations (STAs), starting from an offset number of a traffic indication virtual bitmap in the TIM element. Each bit indicates whether the AP MLD provides the per-link traffic indication for corresponding non-AP MLD or non-AP STA.

In some embodiments, the recommendation field includes a set of bits. Each bit corresponds to a respective one of associated non-AP MLDs and non-AP STAs that are indicated to have buffered traffic in a traffic indication virtual bitmap in the TIM element, starting from an offset number of the traffic indication virtual bitmap in the TIM element. Each bit indicates whether the AP MLD provides the per-link traffic indication for corresponding non-AP MLD or non-AP STA.

In some embodiments, the multi-link traffic indication element optionally includes the recommendation field, and the multi-link traffic indication element includes a recommendation present field that indicates whether the recommendation field is present in the multi-link traffic indication element. The processor is further configured to determine whether the multi-link traffic indication element includes the recommendation field, based on the recommendation present field.

In some embodiments, the multi-traffic indication element includes one or more per-link traffic indication fields. Each field provides a link recommendation or a traffic indication for a respective one of the at least one non-AP MLD.

In some embodiments, the multi-link traffic indication element is included in a group-addressed frame and not associated with the TIM element, including a recommendation field that indicates at least one non-AP MLD for which the AP MLD provides the per-link traffic indication.

### BRIEF DESCRIPTION OF THE DRAWINGS

FIG. 1 shows an example of a wireless network in accordance with an embodiment.

FIG. 2A shows an example of an AP in accordance with an embodiment.

FIG. 2B shows an example of a STA in accordance with an embodiment.

FIG. 3 shows an example of multi-link communication operation in accordance with an embodiment.

FIG. 4 shows an example of a TID-to-Link Mapping element in accordance with an embodiment.

FIG. 5A shows an example of a Multi-Link Traffic Indication element in accordance with an embodiment.

FIG. 5B shows an example of construction of the Multi-Link Traffic Indication element in accordance with an embodiment.

FIG. 6A shows another example of a Multi-Link Traffic Indication element in accordance with an embodiment.

FIGS. 6B and 6C show another example of construction of the Multi-Link Traffic Indication element in accordance with an embodiment.

FIG. 7A shows another example of a Multi-Link Traffic Indication element in accordance with an embodiment.

FIGS. 7B and 7C show another example of construction of the Multi-Link Traffic Indication element when the Recommendation partial virtual bitmap field is present in accordance with an embodiment.

FIG. 8A shows another example of a Multi-Link Traffic Indication element in accordance with an embodiment.

FIG. 8B shows another example of construction of the Multi-Link Traffic Indication element in accordance with an embodiment.

FIG. 9 shows another example of construction of the Multi-Link Traffic Indication element in accordance with an embodiment.

FIG. 10 shows an example of a process for indicating buffered traffic using Multi-Link Traffic Indication element by AP MLD in accordance with an embodiment.

FIG. 11 shows another example of a process for indicating buffered traffic using Multi-Link Traffic Indication element by AP MLD in accordance with an embodiment.

FIG. 12 shows an example of a process for receiving Multi-Link Traffic Indication element by non-AP MLD in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

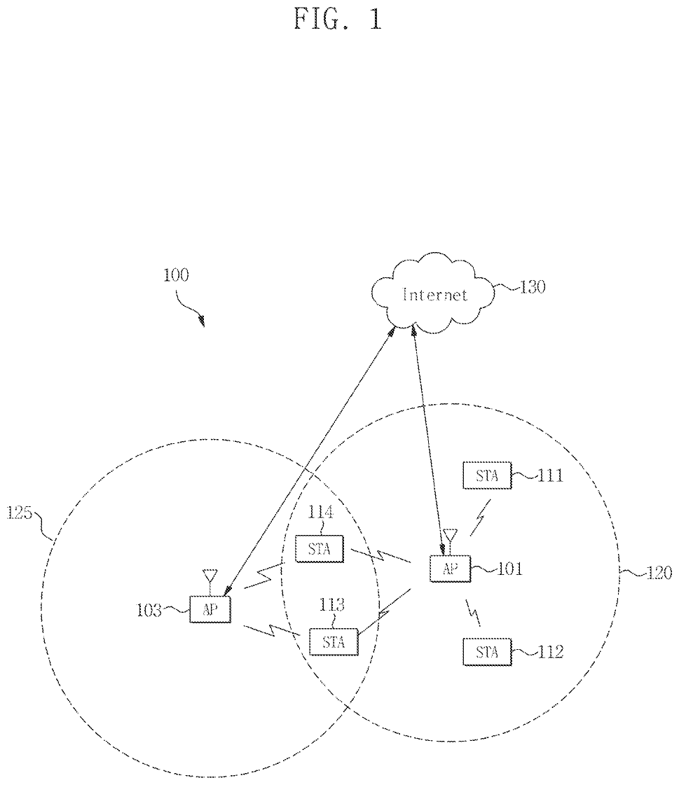

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 includes a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

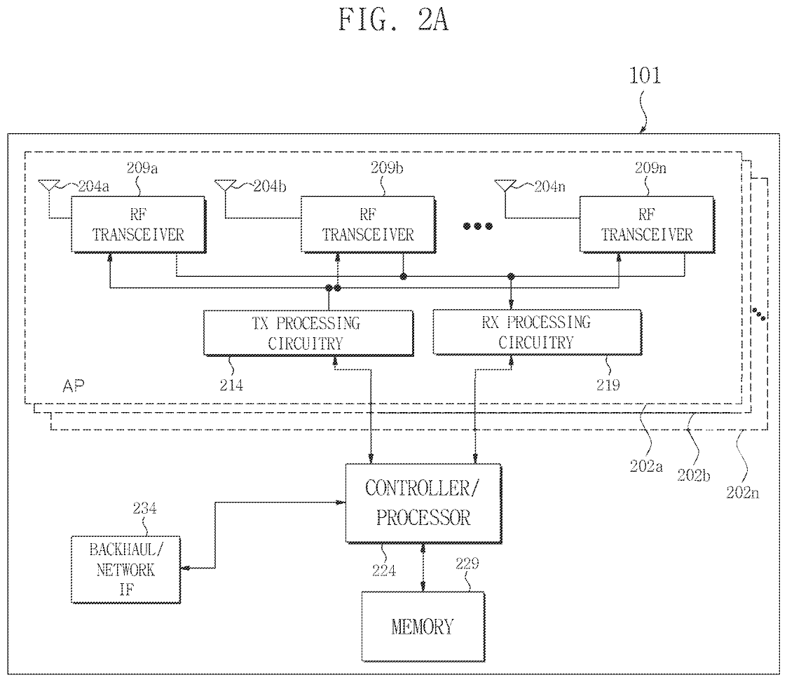

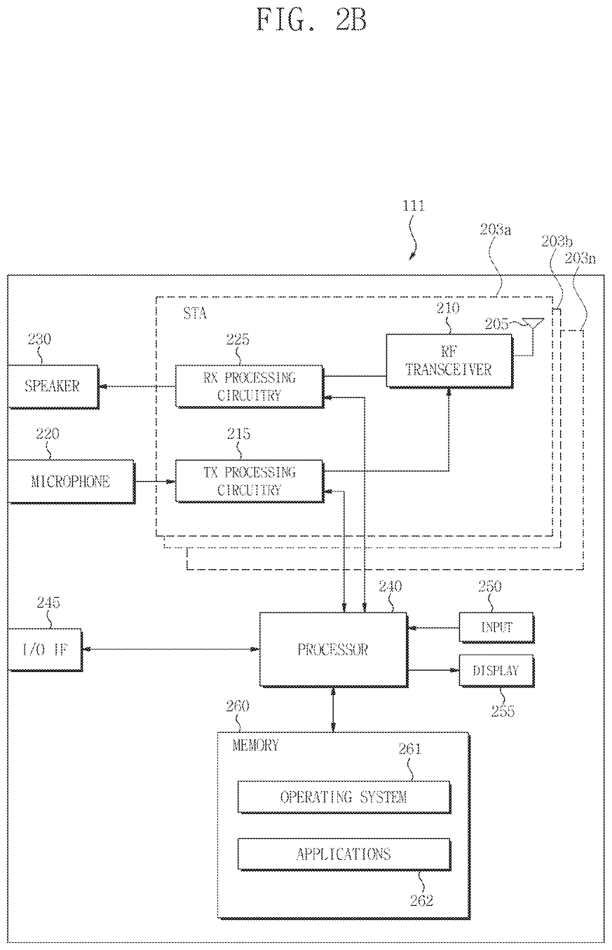

FIG. 2A shows an example of an AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 includes multiple antennas 204a-204n, multiple radio frequency (RF) transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of a STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a RF transceiver 210, TX processing circuitry 215, a microphone 220, and RX processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

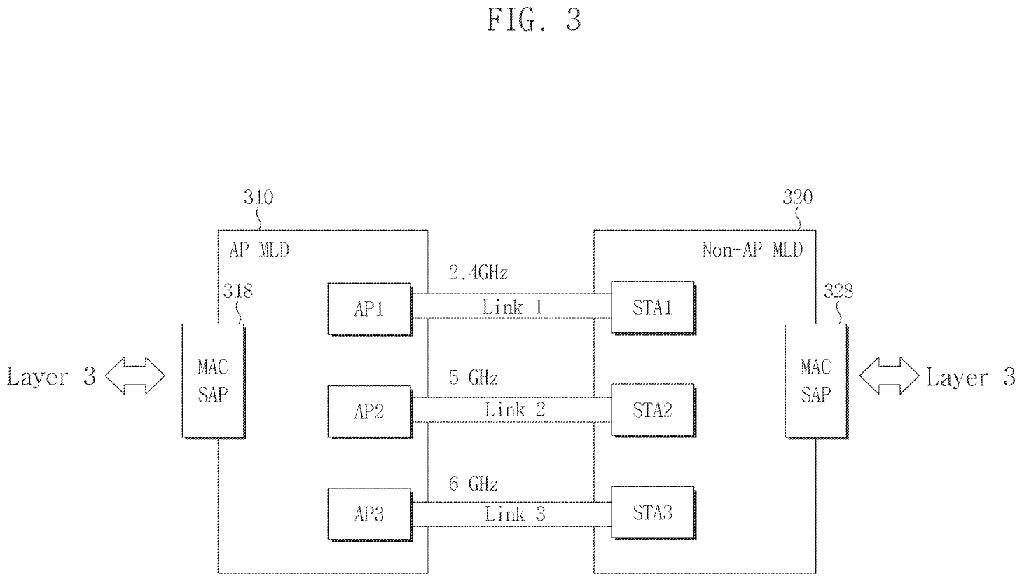

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2 and AP 3. Each affiliated AP includes a PHY interface to wireless medium (Link 1, Link 2, or Link 3). The AP MLD 310 includes a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and the Layer 3 recognizes the AP MLD 310 by assigning the single IP address.

The non-AP MLD 320 may include a plurality of affiliated STAs, for example, including STA 1, STA 2 and STA 3. Each affiliated STA includes a PHY interface to the wireless medium (Link 1, Link 2, or Link 3). The non-AP MLD 320 includes a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and the Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency.

In order to prioritize transmission of different types of traffic, which are identified by a traffic identifier (TID), across the setup links, the non-AP MLD 320 may negotiate a TID-to-link mapping with the AP MLD 310. The TID-to-link mapping allows the AP MLD 310 and the non-AP MLD 320 to determine how frames belonging to TIDs are assigned for transmission on each setup link in the uplink and downlink directions, respectively. When at least one TID associated with a non-AP MLD 320 is mapped to a setup link in either uplink or downlink direction, the link is referred to as an enabled link for the non-AP MLD 320. By default, all TIDs are mapped to all the setup links between the AP MLD 310 and the non-AP MLD 320, and this mapping is referred to as a default TID-to-link mapping. During association, the non-AP MLD 320 can use a negotiation procedure to negotiate a non-default mapping of TIDs to the setup links, by including a TID-to-Link Mapping element in an association request frame or a reassociation request frame. The non-default mapping can be either where all TIDs are mapped to the same subset of setup links, or where not all TIDs are mapped to the same subset of setup links. The AP MLD 310 can also use a broadcast procedure to indicate switching to a non-default mapping for all associated non-AP MLDs. In default mapping mode, all TIDs are mapped to all setup link for downlink and uplink and all setup links are enabled. The non-AP MLD 320 operates under default mapping mode when a TID-to-link mapping negotiation did not occur or was unsuccessful.

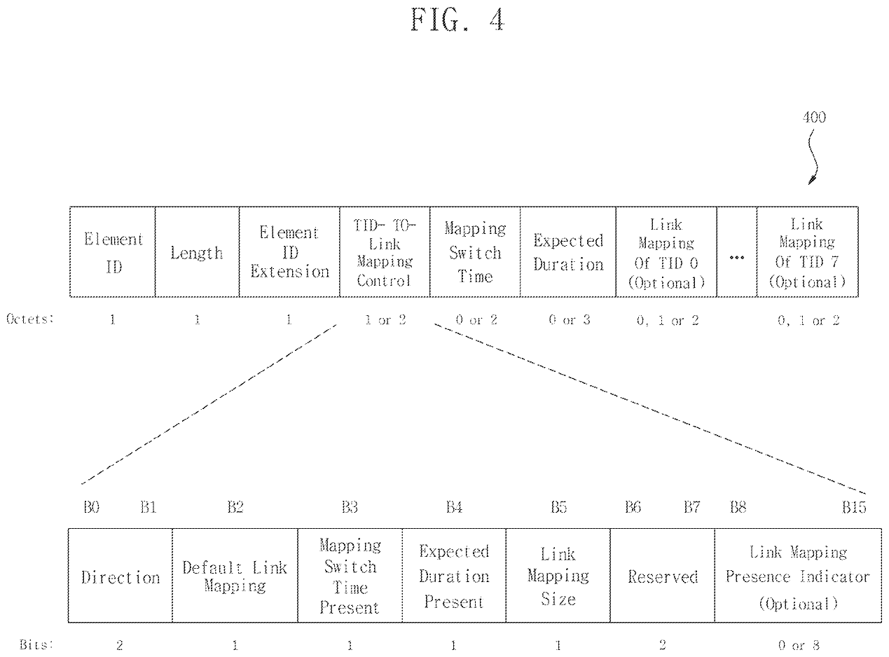

FIG. 4 shows an example of a TID-to-Link Mapping element 400 in accordance with an embodiment. This example of FIG. 4 can be applicable to IEEE 802.11be standard and any of future amendments to IEEE 802.11 standard. The TID-to-Link Mapping element 400 may indicate the links on which frames belongings to each TID can be exchanged.

As shown in FIG. 4, the TID-to-Link Mapping element 400 may include an Element ID field, a Length field, an Element ID Extension field, a TID-to-Link Mapping Control field, a Mapping Switch Time field, an Expected Duration field, and optional Link Mapping of TID n fields.

The Element ID field and the Element ID Extension field may include information to identify the TID-to-Link Mapping element 400. The Length field may indicate a length of the TID-to-Link Mapping element 400.

The TID-to-Link Mapping Control field may include a Direction subfield, a Default Link Mapping subfield, a Mapping Switch Time Present subfield, an Expected Duration Present subfield, a Link Mapping Size subfield, a Reserved subfield, and an optional Link Mapping Presence Indicator subfield. The Direction subfield may indicate if the TID-to-Link Mapping element 400 is for downlink frames, uplink frames, or both. For example, the Direction subfield may be set to 0 for downlink frames, 1 for uplink frames, and 2 for frames transmitted both on downlink and uplink. The Default Link Mapping subfield may indicate if the TID-to-Link Mapping element 400 represents default TID-to-link mapping. For example, the subfield may be set to 1 for default mapping and 0 for non-default mapping. The Mapping Switch Time Present subfield may indicate if the Mapping Switch Time field is present in the TID-To-Link Mapping element 400. The Expected Duration Present subfield may indicate if the Expected Duration field is present in the TID-To-Link Mapping element 400. The Link Mapping Size subfield may indicate the length of the Link Mapping of TID n field. The Link Mapping Presence Indicator subfield may indicate whether the Link Mapping of TID n fields are present in the TID-To-Link Mapping element 400.

The Mapping Switch Time field is present when the TID-to-Link Mapping element 400 is transmitted by an AP affiliated with an AP MLD in a beacon or probe response frame and the indicated TID-to-link mapping is not yet established.

The Expected Duration field may indicate the duration for which the proposed TID-to-link mapping is expected to be effective when the Mapping Switch Time field is present, and the remaining duration for which the proposed TID-to-link mapping is expected to be effective when the Mapping Switch Time field is not present.

The Link Mapping of TID n field (where n=0, 1, . . . , 7, for example) may indicate the links on which frames belonging to the TID n are allowed to be sent. The Link Mapping of TID n fields may carry a bitmap of the links to which the TID n is mapped. When the Default Link Mapping subfield of the TID-To-Link Mapping Control field represents default TID-to-link mapping, the Link Mapping of TID n fields may not be present. For example, when the Direction subfield is set to 0, the Default Link Mapping subfield is set to 0, and the Link Mapping of TID 0 field is configured to 10000 . . . 0, this configuration indicates that downlink data corresponding TID 0 is transmitted on Link 1.

The TID-to-Link Mapping element 400 may be included in various management frames, for example, a beacon frame, an association request/response frame, a re-association request/response frame, or a probe response frame.

In order to allow non-AP MLD to save power, there may be several power management solutions. For example, a STA of the non-AP MLD can be in a doze state for an extended period of time, during which it is not expected to be able to transmit or receive frames. During this time, the corresponding AP of the AP MLD may buffer buffer-able units (BUs) (buffered BUs or buffered traffic) that are addressed to the STA of the non-AP MLD. In order to indicate to all associated non-AP MLDs about the presence of pending BUs via a broadcast or multi-cast signaling, each AP affiliated with the AP MLD periodically includes a traffic information map (TIM) element within the beacon frame it transmits and, each AP affiliated with the AP MLD may optionally transmit a separate periodic broadcast TIM frame. In multi-link operation, the AP of the AP MLD may include a Multi-Link Traffic Indication element in the beacon frame to indicate the link on which the buffered BUs (or buffered traffic) can be retrieved. The BU may be a medium access control (MAC) service data unit (MSDU), aggregate MAC service data unit (MSDU) [quality-of-service (QoS) stations (STAs) only], or bufferable MAC management protocol data unit (MMPDU). The BU may be buffered to operate the power save mode. In this disclosure, the terms ‘buffered traffic’ and ‘buffered BUs’ may be used interchangeably and have the same meaning.

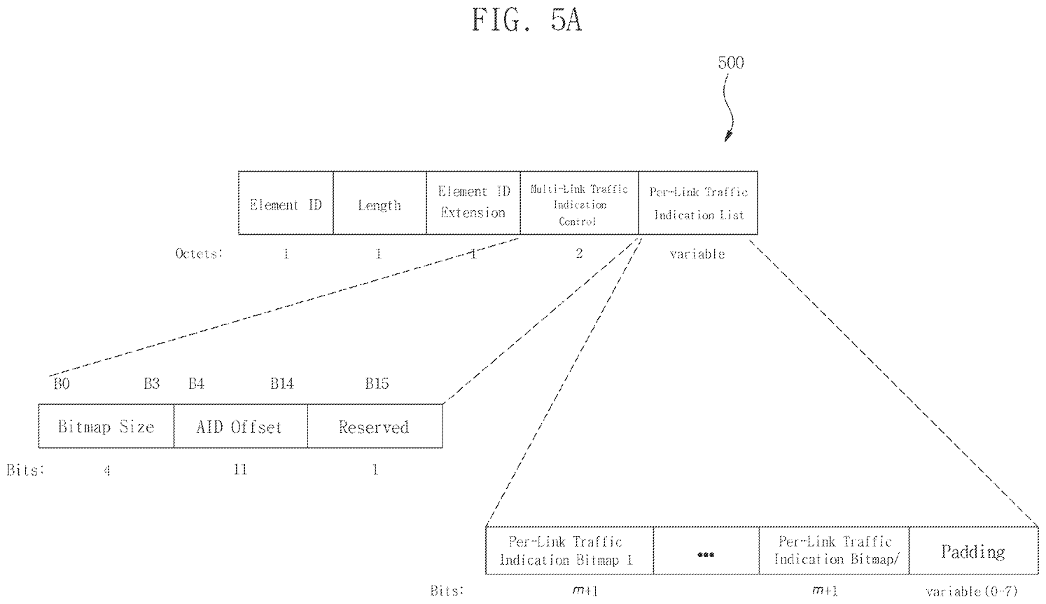

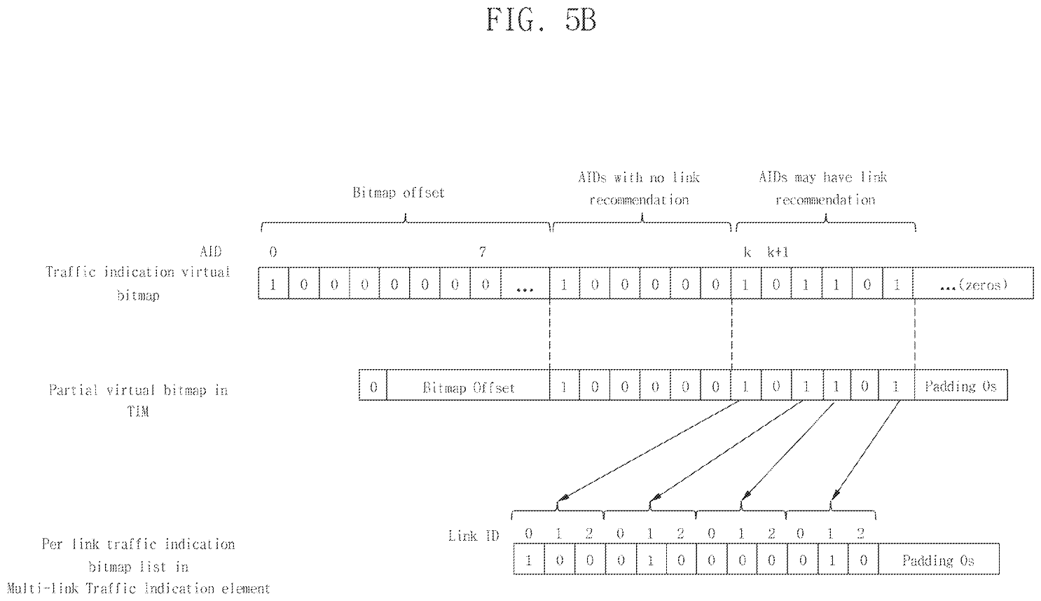

FIG. 5A shows an example of a Multi-Link Traffic Indication element in accordance with an embodiment. This example may be applicable to IEEE 802.11be standard and any of future amendments to IEEE 802.11 standard.

As shown in FIG. 5A, the Multi-Link Traffic Indication element 500 may include an Element ID field, a Length field, an Element ID Extension field, a Multi-Link Traffic Indication Control field, and a Per-Link Traffic indication List field.

The Element ID field and the Element ID extension field may include information to identify the Multi-Link Traffic indication element 500. The Length field may indicate a length of the Multi-Link Traffic indication element 500.

The Multi-Link Traffic Indication Control field may include a Bitmap Size subfield, an association identifier (AID) Offset subfield, and Reserve subfield. The Bitmap Size subfield may indicate the size of each Per-Link Traffic Indication Bitmap subfield in the Per-Link Traffic Indication List field. The AID offset subfield may indicate a bit numbered k of a traffic indication virtual bitmap in the TIM. The traffic indication virtual bitmap indicates presence of pending traffic for a particular STA or non-AP MLD at the AP MLD.

The Per-Link Traffic Indication List field may include a plurality of Per-Link Traffic Indication Bitmap subfields and a Padding subfield. The Per-Link Traffic Indication Bitmap subfields may indicate per-link traffic indication for the non-AP MLD that has negotiated the TID-to-link mapping with the AP MLD and not all TIDs are mapped to all enabled links. In an embodiment, the Per-Link Traffic Indication Bitmap subfield may indicate link recommendation to retrieve buffered traffic for a non-AP MLD that has negotiated a TID-to-link mapping with an AP MLD, where all TIDs are mapped to all the enabled links. In an embodiment, the Per-Link Traffic Indication Bitmap subfield may indicate link recommendation to retrieve buffered traffic for a non-AP MLD in default mapping mode. The Padding subfield may include padding bits to make The Per-Link Traffic Indication List field a multiple of 8 bits.

FIG. 5B shows an example of construction of the Multi-Link Traffic Indication element in accordance with an embodiment.

In FIG. 5B, a traffic indication virtual bitmap and a partial virtual bitmap subfield in TIM element illustrated in the top and middle portions show how to indicate the AID of associated non-AP MLDs and STAs. An AP affiliated with an AP MLD may indicate pending buffered traffic for non-AP MLDs and STAs associated with the AP MLD using the partial virtual bitmap of the TIM element. The partial virtual bitmap subfield in TIM element may include part of the traffic indication virtual bitmap illustrated in the top portion. An AP affiliated with an AP MLD shall include the Multi-Link Traffic Indication element 500, which is partially illustrated on the bottom in FIG. 5B, in a Beacon frame.

As explained, the Multi-Link Traffic Indication element 500 may include Per-Link Traffic Indication Bitmap subfields which correspond to the AIDs of the non-AP MLDs or STAs, starting from the bit number k of the traffic indication virtual bitmap which is indicated in the AID offset subfield in the Multi-Link Traffic Indication element 500. The order of the Per-Link Traffic Indication Bitmap subfields may follow the order of the bits that are set to 1 in the partial virtual bitmap subfield in the TIM element. If a non-AP MLD has a non-default TID-to-link mapping with an AP MLD, the bit position i of the Per-Link Traffic Indication Bitmap subfield for link ID i may be set to 1 if the AP MLD has buffered BUs or medium access control (MAC) management protocol data units (MMPDUs) with TIDs mapped to that link for that non-AP MLD, otherwise the bit shall be set to 0. If a non-AP MLD is in the default mapping mode, the bit position i of the Per-Link Traffic Indication Bitmap subfield for link ID i may be set to 1 if the AP MLD has buffered BUs or MMPDUs and the non-AP MLD may use the link i to retrieve the buffered BUs or MMPDUs. Therefore, the AP MLD may provide link recommendation to the non-AP MLD to use one or more enabled links to retrieve buffered traffic (BUs or MMPDUs).

In the example of FIG. 5B, the first, the third, the fourth, and the sixth AIDs in the partial virtual bitmap subfield in the TIM are set to 1, starting from the bit number k of the traffic indication virtual bitmap which is indicated in the AID offset subfield. The Per-Link Traffic Indication Bitmap subfields correspond to the first, the third, the fourth, and the sixth AIDs in the partial virtual bitmap subfield in ascending order. The first Per-Link Traffic Indication Bitmap subfield may indicate in AID k that the AP MLD has pending buffered traffic in the link 0. Therefore, a non-AP MLD with AID k can retrieve the pending buffered traffic using the link 0. The remaining Per-Link Traffic Indication Bitmap subfields indicate the recommended links in a similar way.

In some implementations, the AP MLD may not provide a link recommendation for many non-AP MLDs. For example, this may occur with the AIDs that have a default TID-to-link mapping or the AIDs that have a non-default mapping, but pending BUs are mapped to all enabled links. The same may be true for individually-addressed management frames that are mapped to all setup links. In such cases, transmission of the Multi-Link Traffic Indication element 500 can be avoided.

In an embodiment, the AP MLD may not provide a Multi-Link Traffic Indication element 500 in the beacon frame if all the associated non-AP MLD for which there are buffered BUs have at least one link with all TIDs mapped to the link. Also, the AP MLD may not provide a Multi-Link Traffic Indication element in the beacon frame if all of the associated non-AP MLD for which there are buffered BUs have a default TID-to-link mapping or all TIDs are mapped to the same subset of links. Therefore, an AP affiliated with an AP MLD may include the Multi-Link Traffic Indication element 500 in the beacon frame when at least one of the associated non-AP MLD has successfully negotiated a TID-to-link mapping and the AP MLD has buffered BU with TIDs that are not mapped to all enabled links for the non-AP MLDs. Therefore, the non-AP MLD may selectively include the Multi-Link Traffic Indication element 500, thereby helping to address the beacon bloating issue.

In some implementations, there may be a mechanism for the AP MLD to indicate to the non-AP MLD in default mapping mode that the AP MLD does not have any link recommendation for non-AP MLDs. In some implementations, there may also be a mechanism for the AP MLD to indicate to the non-AP MLD in non-default mapping mode whether the pending BUs may be fetched or retrieved from any setup link or not.

In an embodiment, when a non-AP MLD has negotiated a non-default TID-to-link mapping, but the pending buffered traffic in the AP MLD is mapped to all enabled links, the AP MLD may do either one of following actions: i) set all bits in the Per-Link Traffic Indication Bitmap subfield corresponding to AID of the non-AP MLD in the Multi-Link Traffic Indication element to 0, indicating that all the buffered traffic may be fetched from any enabled link; or ii) set the bit corresponding to the link i of the AID of the non-AP MLD in the Per-Link Traffic Indication Bitmap subfields of the Multi-Link Traffic Indication element to 1, indicating that the buffered traffic may be fetched from the link i. When at least one pending traffic in the AP MLD for a non-AP MLD is not mapped to all of the enabled links, the AP MLD may not set all bits in the Per-Link Traffic Indication Bitmap subfields corresponding to AID of the non-AP MLD in the Multi-Link Traffic Indication element to 0. When a STA of a non-AP MLD in non-default TID-to-link mapping mode receives a TIM element with the bit corresponding to its AID set to 1, and additionally all bits in the Per-Link Traffic Indication Bitmap subfield corresponding to its AID in the Multi-Link Traffic Indication element may be set to 0, any STA of the non-AP MLD operating on an enabled link may transmit a PS (power save)-Poll frame or U-APSD (unscheduled automatic power save delivery) trigger frame (if the STA is using U-APSD and all access categories are delivery enabled) to retrieve all the buffered BUs from the AP MLD.

In another embodiment, the AP MLD may set all bits in the Per-Link Traffic Indication Bitmap subfield corresponding to the AID of the non-AP MLD, to indicate to the non-AP MLD that “most” of the pending BUs may be fetched from any of enabled links. In another embodiment, the AP MLD may use, for example, an ‘all zero’ indication for a non-AP MLD in default TID-to-link mapping mode to indicate that the AP MLD does not have a recommended link for the non-AP MLD to use to fetch the buffered BUs.

In some implementations, unnecessarily reserved bit to indicate a recommend link may be wasteful and undesirable. It may lead to a very large size of the Multi-Link Traffic Indication element 500, which may reduce efficiency and may make it difficult to fit those bits inside beacon frame. Therefore, there is a need for mechanism to efficiently indicate the recommendation link to fetch buffered BUs only for non-AP MLDs for which the AP MLD has a link recommendation.

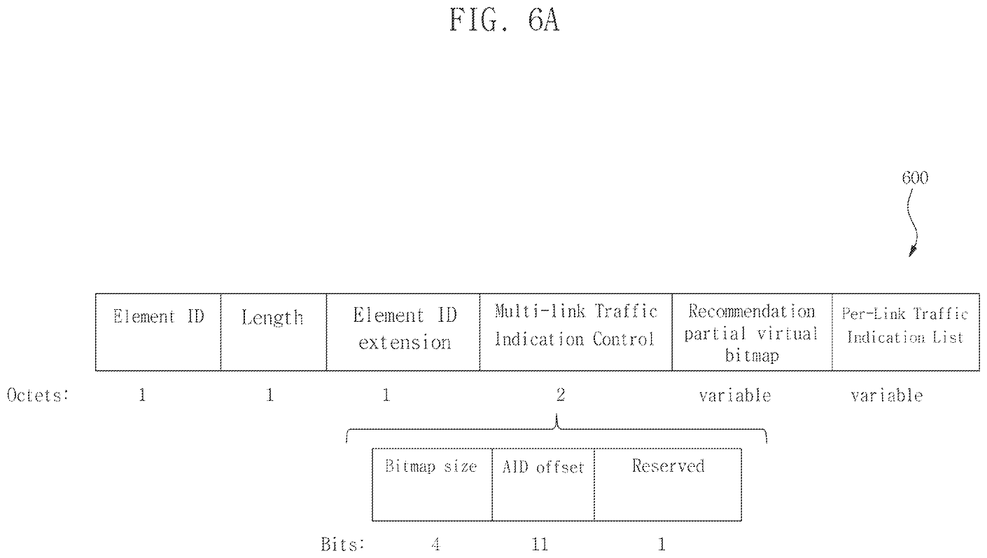

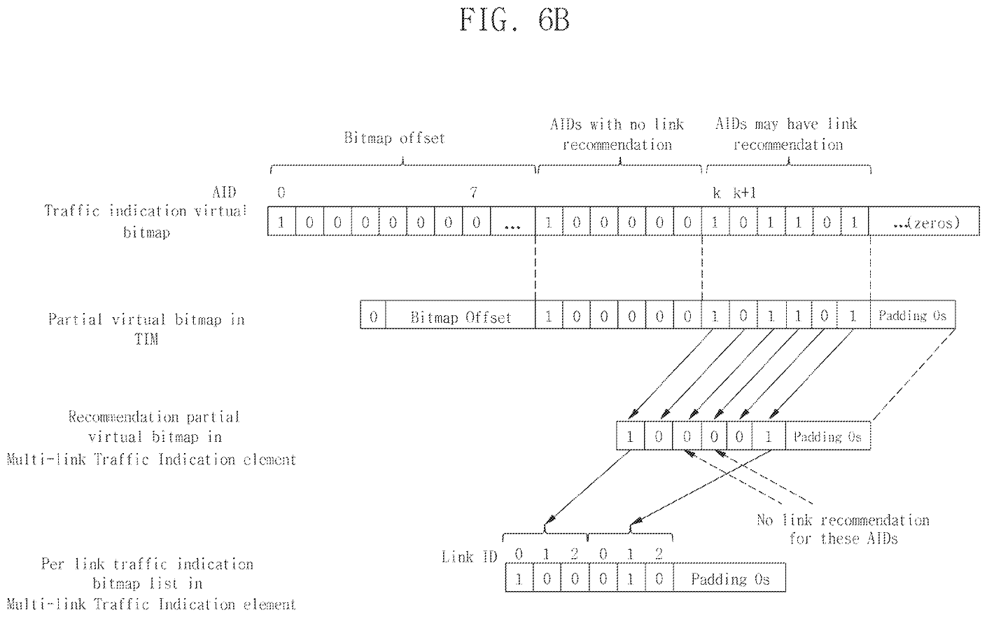

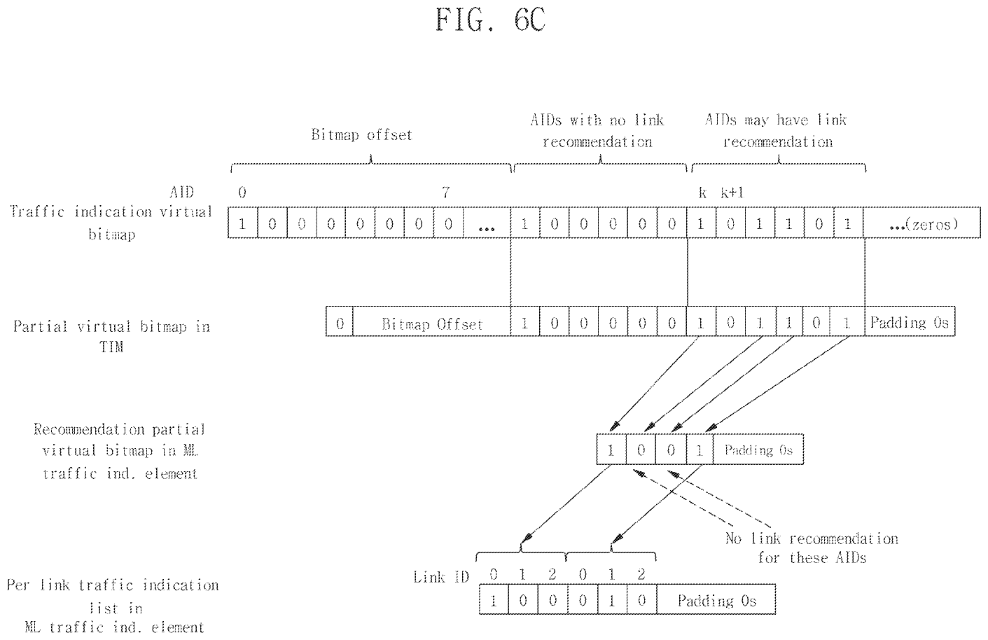

FIG. 6A shows another example of a Multi-Link Traffic Indication element 600 in accordance with an embodiment. FIGS. 6B and 6C show another example of construction of the Multi-Link Traffic Indication element in accordance with an embodiment. This example may be applicable to IEEE 802.11be standard and any of future amendments to IEEE 802.11 standard.

As shown in FIG. 6A, the Multi-Link Traffic Indication element 600 may include an Element ID field, a Length field, an Element ID Extension field, a Multi-Link Traffic Indication Control field, and a Recommendation partial virtual bitmap field, and a Per-Link Traffic indication List field. The Multi-Link Traffic Indication Control field may include a Bitmap size subfield, an AID offset subfield and a Reserved subfield.

In some aspects, the various fields or subfields in the Multi-Link Traffic Indication element 600 may be the same as or similar to corresponding fields or subfields in the Multi-Link Traffic Indication element 500 in FIG. 5A, with examples of differences described below. For instance, the Multi-Link Traffic Indication element 600 may include an additional field, called the Recommendation partial virtual bitmap field.

Referring to FIGS. 6A and 6B, the AID offset subfield in the Multi-Link Traffic Indication element 600 may indicate a bit number k of the traffic indication virtual bitmap. The Recommendation partial virtual bitmap field may have bits for all AIDs in the partial virtual bitmap subfield of the TIM element, starting from AID k that is indicated in the AID offset subfield. A bit for a particular AID may be set to 1 only if the AP MLD has pending BUs for the AID and the AP MLD has a recommended link to retrieve the pending BUs. Otherwise, the bit for the AID may be set to 0. The bit may always be set to 0 for a non-MLD STA or a non-AP MLD with a single enabled link.

The length of the Recommendation partial virtual bitmap field, excluding the zero Paddings, may be the same as the length of the partial virtual bitmap subfield in the TIM element as shown in FIG. 6B. In one embodiment, zero padding may be used to make the length of the field a multiple of 8 bits. In one embodiment, the Multi-Link Traffic Indication element 600 may additionally have a Recommendation partial virtual bitmap length field to indicate the length of the Recommendation partial virtual bitmap field in octets.

The Per-Link Traffic Indication List field in the Multi-Link Traffic Indication element 600 may include a plurality of Per-Link Traffic Indication Bitmap subfields and a Padding subfield in the similar way as shown in FIGS. 5A and 5B. The Per-Link Traffic Indication Bitmap subfields may correspond to the AIDs of the non-AP MLD and STAs and set to 1, starting from the bit number k of the traffic indication virtual bitmap as shown in FIG. 6B. The Per-Link Traffic Indication List field may contain l Per-Link Traffic Indication Bitmap subfields, where I is the number of the bits that correspond to the AIDs of the non-AP MLDs and STAs and set to 1, starting from AID k, in the Recommendation partial virtual bitmap field of the Multi-link Traffic Indication element 600.

In the example of FIG. 6B, there are 4 bits set to 1 that correspond to 4 AIDs (i.e., AID k, AID k+2, AID k+3, and AID k+5) in the partial virtual bitmap subfield in the TIM element. However, only 2 bits that correspond to 2 AIDs (i.e., AID k and AID k+5) are set to 1 in the Recommendation partial virtual bitmap because the AP MLD has no link recommendation for AID k+2 and AID k+3 which are set to 1 in the Partial virtual bitmap. As a result, the Per-Link Traffic Indication List field contains only two Per-Link Traffic Indication Bitmap subfields which correspond to AID k and AID k+5 which is set to 1 in the Recommendation partial virtual bitmap. The first Per-Link Traffic Indication bitmap subfield indicates Link 0 as a recommendation link for the non-AP MLD with AID k and the second Per-Link Traffic Indication bitmap subfield indicates Link 1 as a recommendation link for the non-AP MLD with AID k+5 by setting bits corresponding to recommended links to 1 and the others bit to 0.

In an embodiment, the Recommendation partial virtual bitmap field can be carried in an information element or frame that is different from the Multi-link Traffic indication element 600. For example, it may be carried in the TIM element or in an EHT action frame.

FIG. 6C shows another example of construction of the Multi-Link Traffic Indication element in accordance with an embodiment. This example of FIG. 6C uses the Multi-Link Traffic Indication element 600 described in reference to FIGS. 6A and 6B, with examples of differences described below.

The length of the Recommendation partial virtual bitmap field may be equal to the number l of bits (excluding the zero Paddings) that correspond to the AIDs of the non-AP MLD or STAs and set to 1, starting from the bit numbered k of the partial virtual bitmap subfield of the TIM element. The order of the bits in the Recommendation Partial Virtual bitmap field may follow the order of AID bits of the non-AP MLD or STAs that is set to 1 in the partial virtual bitmap of the TIM element. In FIG. 6C, if AID k+3 is the third bit set to 1 in the partial virtual bitmap of the TIM element (counting from AID k), the third bit of the Recommendation partial virtual bitmap filed in Multi-Link Traffic Indication element 600 corresponds to the AID k+3. The length of the Recommendation partial virtual bitmap field may be inferred from the number of bits set to 1 in the partial virtual bitmap of the TIM element, starting from AID k. In an embodiment, zero padding may be used to make the length of this field a multiple of 8 bits. In an embodiment, the Multi-Link Traffic Indication element 600 may additionally have a Recommendation partial virtual bitmap length field to indicate the length of the Recommendation partial virtual bitmap field in octets. In FIG. 6C, the length of the Recommendation partial virtual bitmap field is 4 bits excluding zero Paddings, while the length of the partial virtual bitmap subfield in the TIM element is 6 bits because only 4 bits that correspond to 4 AIDs (i.e., AID k, AID k+2, AID k+3, AID k+5) out of 6 AIDs set to 1, counting from the AID k. As a result, the length of Recommendation partial virtual bitmap field can be reduced by 2 bits compared to the embodiment of FIG. 6B.

The Per-Link Traffic Indication List field in the Multi-Link Traffic Indication element 600 may include a plurality of Per-Link Traffic Indication Bitmap subfields and a Padding subfield in the similar way as shown in FIG. 6B. The Per-Link Traffic Indication Bitmap subfields correspond to the AIDs of the non-AP MLD and STAs and set to 1, starting from the bit number k of the Traffic indication virtual bitmap as shown in FIG. 6C. The Per-Link Traffic Indication List field contains 1 Per-Link Traffic Indication Bitmap subfields, where I is the number of the bits that correspond to the AIDs of the non-AP MLDs and STAs and set to 1 in the Recommendation partial virtual bitmap field of the Multi-link Traffic Indication element 600.

In the example of FIG. 6C, there are 4 bits set to 1 that correspond to 4 AIDs (i.e., AID k, AID k+2, AID k+3, and AID k+5) in the partial virtual bitmap subfield in the TIM element. However, only 2 bits that correspond to 2 AIDs (i.e., AID k and AID k+5) are set to 1 in the Recommendation partial virtual bitmap because the AP MLD has no link recommendation for AID k+2 and AID k+3 which are set to 1 in the Partial virtual bitmap. As a result, the Per-Link Traffic Indication List field contains only two Per-Link Traffic Indication Bitmap subfields which correspond to AID k and AID k+5 which is set to 1 in the Recommendation partial virtual bitmap. The first Per-Link Traffic Indication bitmap subfield indicates Link 0 as a recommendation link for the non-AP MLD with AID k and the second Per-Link Traffic Indication bitmap subfield indicates Link 1 as a recommendation link for the non-AP MLD with AID k+5 by setting bits corresponding to recommended links to 1 and the others bit to 0.

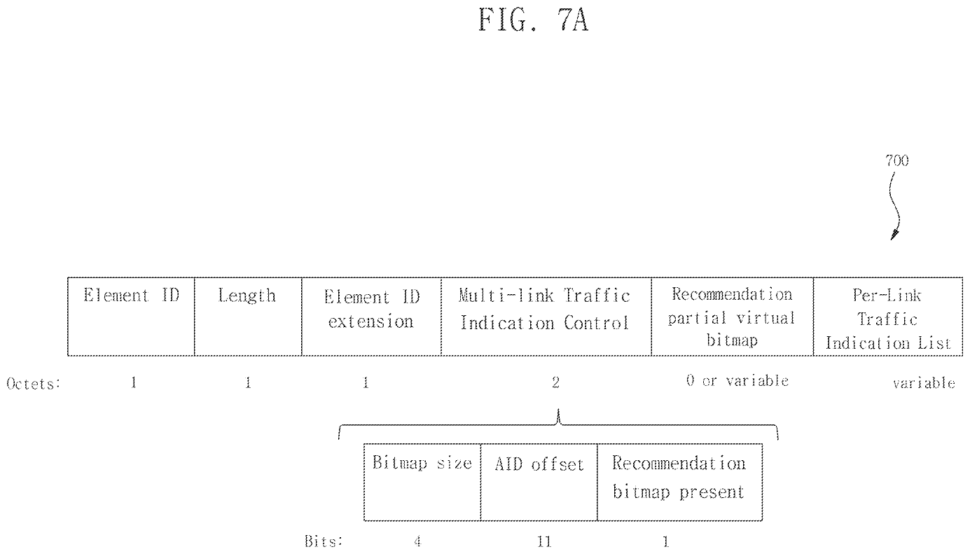

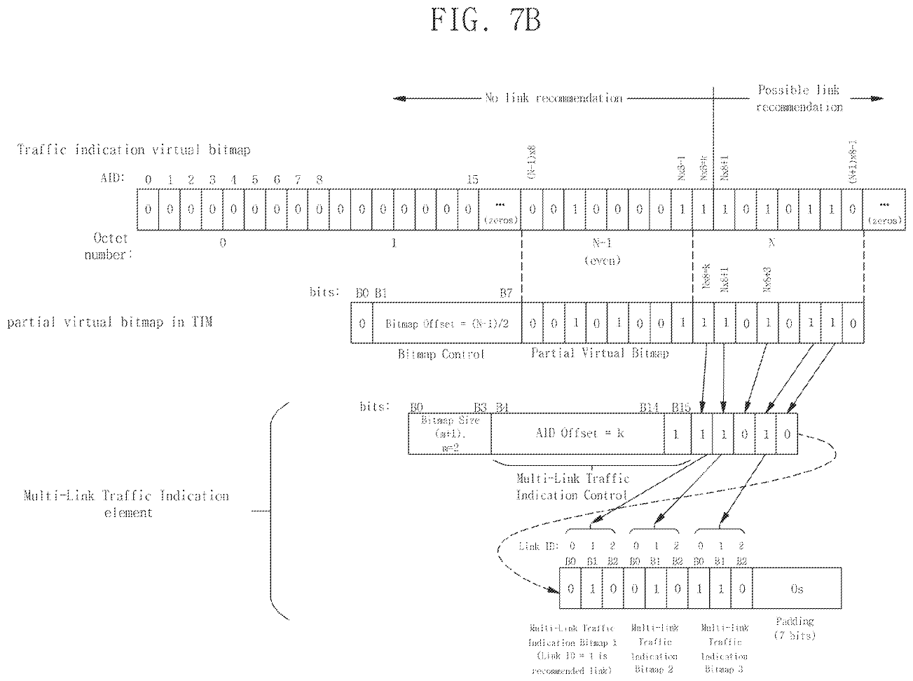

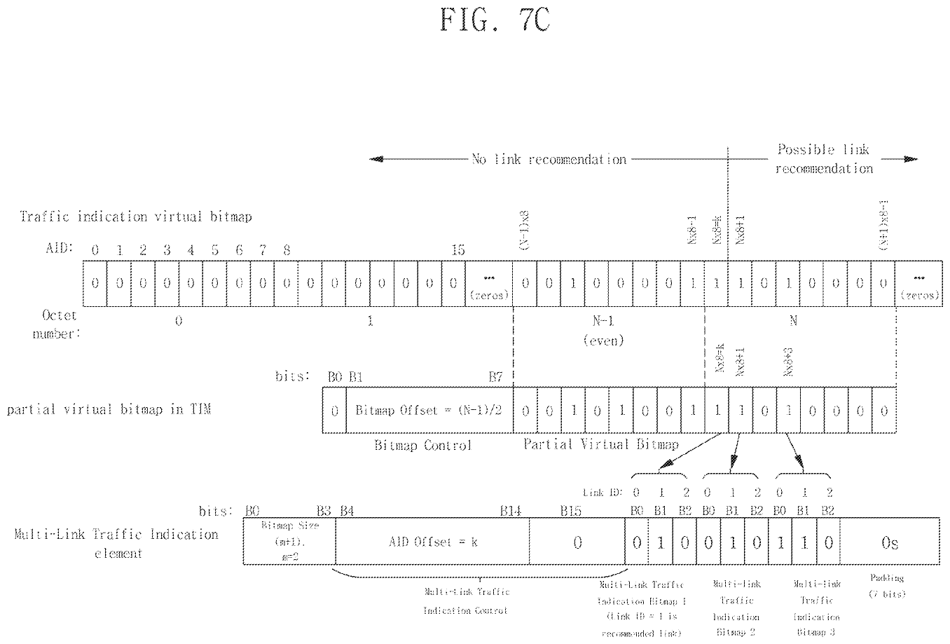

FIG. 7A shows another example of a Multi-Link Traffic Indication element 700 in accordance with an embodiment. This example may be usable in IEEE 802.11be standard and any of future amendments to IEEE 802.11 standard.

As shown in FIG. 7A, the Multi-Link Traffic Indication element 700 may include an Element ID field, a Length field, an Element ID Extension field, a Multi-Link Traffic Indication Control field, an optional Recommendation partial virtual bitmap field, and a Per-Link Traffic indication List field. The Multi-Link Traffic Indication Control field may include a Bitmap size subfield, an AID offset subfield, and a Recommendation bitmap present subfield.

In some aspects, the various fields or subfields in the Multi-Link Traffic Indication element 700 may be the same as or similar to corresponding fields or subfields in the Multi-Link Traffic Indication element 600 in FIG. 6A, with examples of differences described below. For instance, the Multi-Link Traffic Indication element 700 may include additional subfield in the Multi-Link Traffic Indication Control field, called the Recommendation bitmap present subfield. The Recommendation bitmap present subfield indicates whether the optional Recommendation partial virtual bitmap field is present. The Recommendation bitmap present subfield is set to 1 if the Recommendation partial virtual bitmap field is present. Otherwise, the Recommendation bitmap present subfield is set to 0.

FIG. 7B shows another example of construction of the Multi-Link Traffic Indication element when the Recommendation partial virtual bitmap field is present in accordance with an embodiment. In FIG. 7B, the Recommendation bitmap present subfield (B15) in the Multi-Link Traffic Indication Control field is set to 1 to indicate the presence of the optional Recommendation partial virtual bitmap field. The order of the AIDs and the indication of the recommendation links in the Per-Link Traffic Indication List field is the same as or similar to FIG. 6C. The Per-Link Traffic Indication List field may contain l Per-Link Traffic Indication Bitmap subfields, where I is the number of the bits that correspond to the AIDs of the non-AP MLDs and STAs and set to 1 in the Recommendation partial virtual bitmap field of the Multi-link Traffic Indication element 700.

FIG. 7C shows another example of construction of the Multi-Link Traffic Indication element when the Recommendation partial virtual bitmap field is not present in accordance with an embodiment. In FIG. 7C, the Recommendation bitmap present subfield (B15) in the Multi-Link Traffic Indication Control field is set to 0 to indicate the absence of the optional Recommendation partial virtual bitmap field. The order of the AIDs and indication of recommendation link in the Per-Link Traffic Indication List field is the same as or similar to FIG. 5B. The Per-Link Traffic Indication List field contains 1 Per-Link Traffic Indication Bitmap subfields, where l is the number of the bits that correspond to the AIDs of the non-AP MLDs and STAs and set to 1, starting from AID k in the Partial Virtual Bitmap subfield of the TIM element that is included in a Beacon frame with the Multi-Link Traffic Indication element.

The AP MLD may determine whether to include the Recommendation partial virtual bitmap field based, for example, on the number of AIDs with pending traffic and the number of AIDs for which the AP MLD has link recommendations to fetch the pend traffic.

When the Recommendation partial virtual bitmap field is present, if a non-AP MLD receives a TIM element with the partial virtual bitmap set to 1 for its AID and a Multi-Link Traffic Indication element 700 with the recommendation partial virtual bitmap for its AID set to 0, then the non-AP MLD may not decode the remaining part of the Multi-Link Traffic Information element. In an embodiment, the non-AP MLD may use any of enabled links to fetch the pending BUs at the AP MLD. In another embodiment, the non-AP MLD may use any of enabled links which have all TIDs mapped to it to fetch the pending BUs at the AP MLD.

In an embodiment, if the Recommendation partial virtual bitmap field is present and a non-AP MLD receives a Multi-Link Traffic Indication element 700 with the Recommendation partial virtual bitmap set to 1 for its AID, or if the Recommendation partial virtual bitmap field is not present, the non-AP MLD may parse the Per-Link Traffic Indication List field to determine the list of recommended links for the non-AP MLD.

In another embodiment, the Recommendation partial virtual bitmap field may be carried in an information element or frame that is different from the Multi-link Traffic indication element 700. For example, it may be carried in the TIM element or in an EHT action frame.

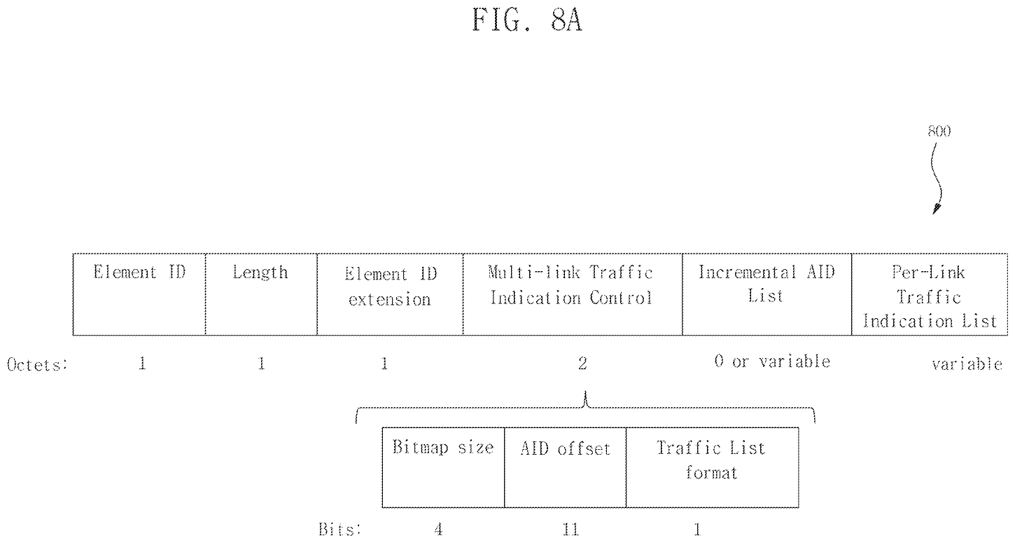

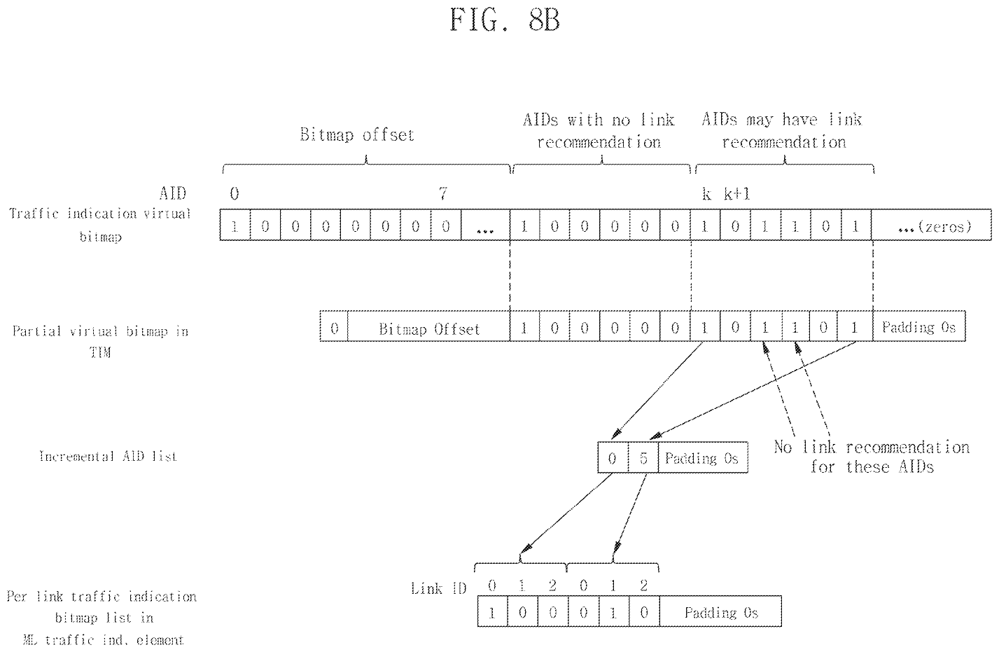

FIG. 8A shows another example of a Multi-Link Traffic Indication element 800 in accordance with an embodiment. This example may be usable in IEEE 802.11be standard and any of future amendments to IEEE 802.11 standard.

As shown in FIG. 8A, the Multi-Link Traffic Indication element 800 may include an Element ID field, a Length field, an Element ID Extension field, a Multi-Link Traffic Indication Control field, an optional Incremental AID List field, and a Per-Link Traffic indication List field. The Multi-Link Traffic Indication Control field may include a Bitmap size subfield, an AID offset subfield, and a Traffic List format subfield.

In some aspects, the various fields or subfields in the Multi-Link Traffic Indication element 800 may be the same as or similar to corresponding fields or subfields in the Multi-Link Traffic Indication element 700 in FIG. 7A, with examples of differences described below. For instance, the Multi-Link Traffic Indication element 800 may include the optional Incremental AID List field instead of the optional Recommendation partial virtual bitmap field in the Multi-Link Traffic Indication element 700 of FIG. 7A. In addition, the Multi-Link Traffic Indication element 800 may include the Traffic List format subfield in the Multi-Link Traffic Indication Control field instead of the Recommendation bitmap present subfield. The Traffic List format subfield may indicate whether the Incremental AID List field is present. The Traffic List format subfield may be set to 1 if the Incremental AID List field is present. Otherwise, the Traffic List format subfield may be set to 0.

If the Traffic List format subfield is set to 0, the Incremental AID List field may be absent and the Per-Link Traffic Indication List field may contain l Per-Link Traffic Indication Bitmap subfields, where l is the number of the bits that correspond to the AIDs of the non-AP MLDs and STAs and set to 1 in the partial Virtual Bitmap subfield of the TIM element. The order of the AIDs and indication of recommendation link in the Per-Link Traffic Indication List field may be the same as or similar to FIG. 5B.

If the Traffic List format subfield is set to 1, the Incremental AID List field may be present and the Incremental AID List field may indicate the list of AIDs for which the AP MLD provides link recommendations to fetch pending BUs. In this embodiment, instead of indicating the actual AID value, only the incremental value with respect to k is indicated. The size of each incremental AID value in bits may be ┌log₂ m┐, where m is the number of bits in the partial virtual bitmap subfield of the TIM element, starting from the bit corresponding to AID k. The Per-Link Traffic Indication List field may contain l Per-Link Traffic Indication Bitmap subfields, where l is the number of the bits that correspond to the AIDs of the non-AP MLDs and STAs with the incremental AID values (with respect to k) as indicated in the Incremental AID List field. The number of Per-Link Traffic Indication Bitmap subfields may be the same as the number of entries in the Incremental AID list. A particular AID may be included by the AP MLD in the Incremental AID List field and, correspondingly, in the Per-Link Traffic Indication List field only if the AP MLD has pending BUs for that AID and the AP MLD provides a link recommendation for the AID to fetch the buffered traffic. Otherwise, the AID may not be included in the Incremental AID List field and in the Per-Link Traffic Indication List field. The AID corresponding to a non-MLD STA or a non-AP MLD with a single enabled link may always be excluded.

FIG. 8B shows another example of construction of the Multi-Link Traffic Indication element in accordance with an embodiment.

In FIG. 8B, the Incremental AID List format field has the list of AIDs including AID k and AID k+5 in the partial virtual bitmap subfield. Since there is no corresponding incremental value for AID k+2 and AID k+3 even if corresponding bits in the partial virtual bitmap subfield are set to 1, there is no link recommendation for AID k+2 and AID k+3 in the Per-link Traffic Indications List field. Therefore, the Per-Link Traffic Indication List field contains 2 Per-Link Traffic Indication Bitmap subfields, because the Incremental AID List field has two bits corresponding to AID k and AID k+5.

In another embodiment, for any AID x the increment AID value may hold the count of the number of bits set to 1 between the bit for AID k and the bit corresponding to AID x, and the size of each incremental AID value in bits can be ┌log₂ l┐, where l is the number of bits set to 1 in the partial virtual bitmap of the TIM element.

In an embodiment, the length of each of this incremental AID value in the Incremental AID List format field may be indicated in a separate and optional Incremental AID length field or subfield of the Multi-Link Traffic Indication element.

If a non-AP MLD receives a TIM element with the Partial Virtual bitmap for its AID set to 1 and a Multi-Link Traffic Indication element 800 in which the Incremental AID List field does not contain its corresponding incremental value (with respect to k), the non-AP MLD may not decode the remaining part of the Multi-Link Traffic Indication element 800. In this case, the non-AP MLD may use any of its enabled links to fetch the pending BUs at the AP MLD. In one embodiment, the non-AP MLD may use any of its enabled links which have all TIDs mapped to the enabled link to fetch the pending buffered BUs at the AP MLD.

In an embodiment, if a non-AP MLD receives a Multi-Link Traffic Indication element 800 in which the Incremental AID List field contains its corresponding incremental value (with respect to k) or if the Traffic List format subfield is set to 0, the non-AP MLD may parse the Per-Link Traffic Indication List field to determine a link recommendation for the non-AP MLD.

In another embodiment, the Incremental AID list field may be carried in an information element or frame that is different from the Multi-link Traffic indication element 800. For example, they may be carried in the TIM element or in an EHT action frame.

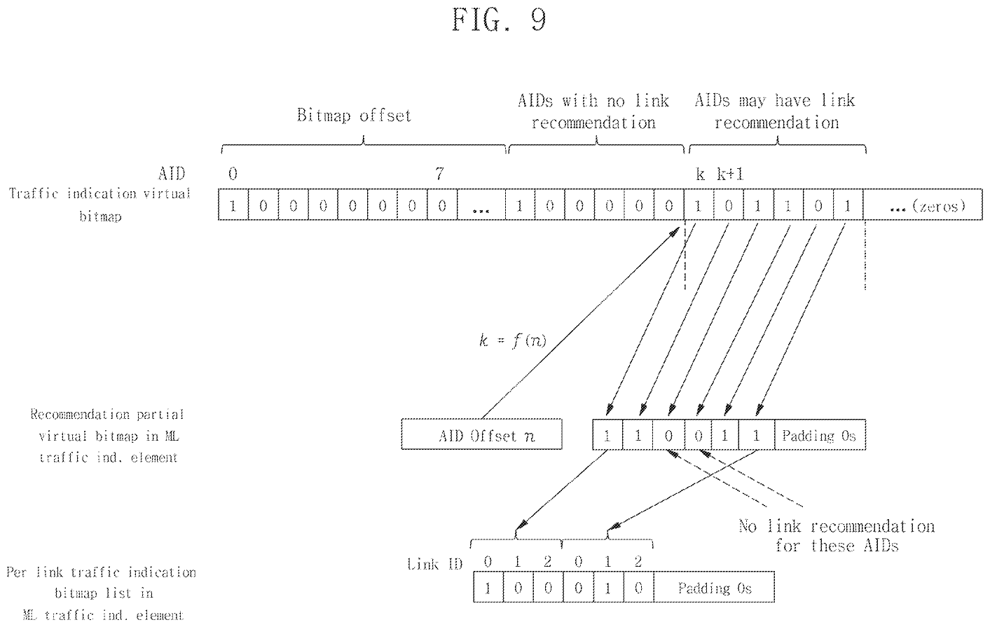

FIG. 9 shows another example of construction of the Multi-Link Traffic Indication element in accordance with an embodiment.

The Multi-Link Traffic Indication element may also be transmitted, without an associated TIM element, in an individually-addressed or group-addressed frame. In this example, the Multi-Link Traffic Indication element may be referred to as a “long-term” Multi-Link Traffic Indication element.

The long-term Multi-Link Traffic Indication element may be the same as or similar to the Multi-Link Traffic Indication element 600 in FIG. 6A, except for the AID offset subfield which indicates a number n as shown in FIG. 9. The Recommendation partial virtual bitmap field may have bits for all the AIDs, starting from AID f(n). Here, f(n) may be some function of n, for example 2n, 8n, or 16n. A bit for a particular AID in the Recommendation partial virtual bitmap field may be set to 1 only if the AP MLD intends to provide a link recommendation to fetch the buffered pending traffic to the non-AP MLD with the AID. Otherwise, the bit for the AID may be set to 0. In an embodiment, zero padding may be used to make the length of this field a multiple of 8 bits.

In an embodiment, the long-term Multi-Link Traffic Indication element may additionally have a Recommendation partial virtual bitmap length field to indicate the length of the Recommendation partial virtual bitmap field in octets.

A non-AP MLD that receives the long-term Multi-Link Traffic Indication element may use recommended link set to fetch pending buffered traffic indicated in all subsequent TIM elements, unless the TIM element is accompanied by an associated Multi-Link Traffic Indication element that recommends an alternate link set to fetch buffered traffic indicated in the TIM element. Thus, the long-term Multi-Link Traffic Indication element without an associated TIM element may be indicated a “long-term” link recommendation to a non-AP MLD.

A newly received long-term Multi-Link Traffic Indication element may replace indications by the previous long-term Multi-Link Traffic Indication element for the non-AP MLD. If a link recommendation is included for a non-AP MLD in a new long-term Multi-Link Traffic Indication element and the bits for all the links are set to 1, it may indicate that the previous long-term Multi-Link Traffic Indication element is being torn-down or deactivated for the non-AP MLD. In an embodiment, the AP MLD may not provide a Multi-Link Traffic Indication element in the beacon frame along with the TIM element if the link recommendation in the long-term Multi-Link Traffic Indication element is both sufficient and valid to retrieve the buffered traffic for all the associated non-AP MLD for which there are buffered BUs.

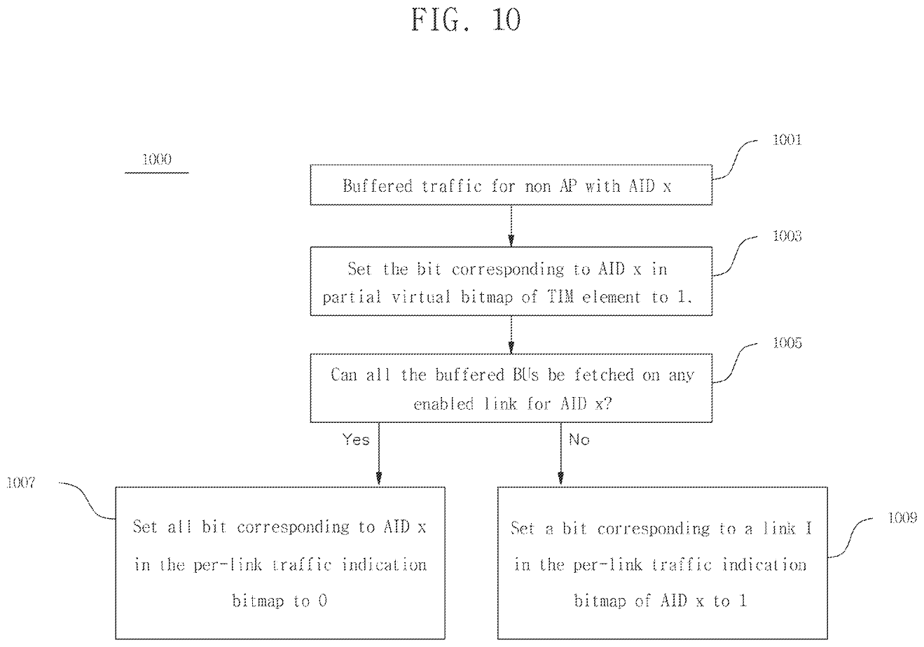

FIG. 10 shows an example of a process 1000 for indicating buffered traffic using Multi-Link Traffic Indication element by AP MLD in accordance with an embodiment.

In operation 1001, the AP MLD determines whether the AP MLD has pending buffered traffic for a non-AP MLD with AID x. The process 1000 proceeds to operation 1003 when the AP MLD has pending buffered traffic for the non-AP MLD with AID x. In an embodiment, this process 1000 operates when the non-AP MLD that is associated with the AP MLD has negotiated a non-default TID-to-link mapping, but the pending buffered traffic at the AP MLD is mapped to all the enabled link.

In operation 1003, the AP MLD sets the bit corresponding to AID x in partial virtual bitmap subfield of the TIM element to 1. Then, the process 1000 proceeds to operation 1005.

In operation 1005, the AP MLD determines whether all buffered traffic can be fetched from any enabled links by the non-AP MLD with AID x. The process 1000 proceeds to operation 1007 when all buffered traffic can be fetched from any enabled links by the non-AP MLD with AID x, and otherwise proceeds to operation 1009.

In operation 1007, the AP MLD sets all bits corresponding to AID x of the non-AP MLD in the Per-Link Traffic Indication bitmap subfield of the Multi-Link Traffic Indication element to 0. It indicates that all buffered traffic can be fetched from any enabled links of the non-AP MLD with the AID x.

In operation 1009, the AP MLD does not set all the bits corresponding to AID x of the non-AP MLD in the Per-Link Traffic Indication bitmap subfield of the Multi-Link Traffic Indication element to 0. The AP MLD may set a bit corresponding to a link i of the non-AP MLD with AID x in the Per-Link Traffic Indication bitmap subfield of the Multi-Link Traffic Indication element to 1 in order to indicate that pending buffered traffic can be fetched from the link i.

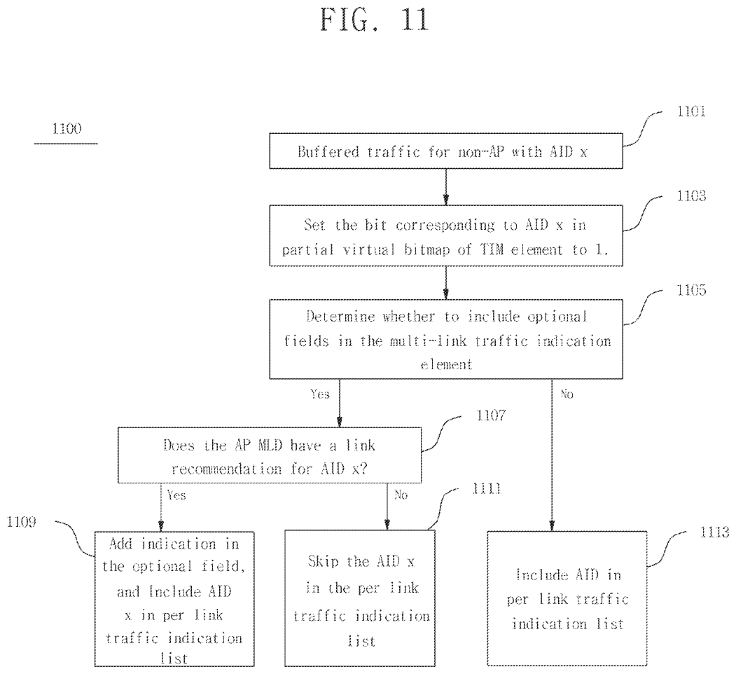

FIG. 11 shows another example of a process 1100 for indicating buffered traffic using Multi-Link Traffic Indication element by AP MLD in accordance with an embodiment.

In operation 1101, the AP MLD determines whether the AP MLD has pending buffered traffic for a non-AP MLD with AID x. The process 1100 proceeds to operation 1103 when the AP MLD has pending buffered traffic for the non-AP MLD with AID x.

In operation 1103, the AP MLD sets the bit corresponding to AID x in partial virtual bitmap subfield of the TIM element to 1. Then, the process 1100 proceeds to operation 1105.

In operation 1105, the AP MLD determines whether to include optional fields in the Multi-Link Traffic Indication element. In an embodiment, the optional fields can be the Recommendation partial virtual bitmap field, the Recommendation partial virtual bitmap length field, the Recommendation bitmap present subfield, the Incremental AID List field, or the Traffic List format subfield explained in reference to FIGS. 6A-9. The process 1100 proceeds to operation 1107 when the AP MLD includes an optional field in the Multi-Link Traffic Indication element. Otherwise, proceeds to operation 1113.

In operation 1107, the AP MLD determines whether to have a link recommendation for the non-AP MLD with AID x. The process 1100 proceeds to operation 1109 when the AP MLD have a link recommendation for the non-AP MLD with AID x. Otherwise, proceeds to operation 1111.

In operation 1109, the AP MLD includes the optional field in the Multi-Link Traffic Indication element. For example, the optional field may be the Recommendation partial virtual bitmap field, the Recommendation partial virtual bitmap length field, the Recommendation bitmap present subfield, the Incremental AID List field, or the Traffic List format subfield. Additionally, the AP MLD includes AID x of the non-AP MLD in the Per-Link Traffic Indication List field in the Multi-Link Traffic Indication element.

In operation 1111, the AP MLD includes the optional field in the Multi-Link Traffic Indication element. For example, the optional field may be the Recommendation partial virtual bitmap field, the Recommendation partial virtual bitmap length field, the Recommendation bitmap present subfield, the Incremental AID List field, or the Traffic List format subfield. However, the AP MLD does not include AID x of the non-AP MLD in the Per-Link Traffic Indication List field in the Multi-Link Traffic Indication element.

In operation 1113, the AP MLD includes AID x of the non-AP MLD in the Per-Link Traffic Indication List field in the Multi-Link Traffic Indication element.

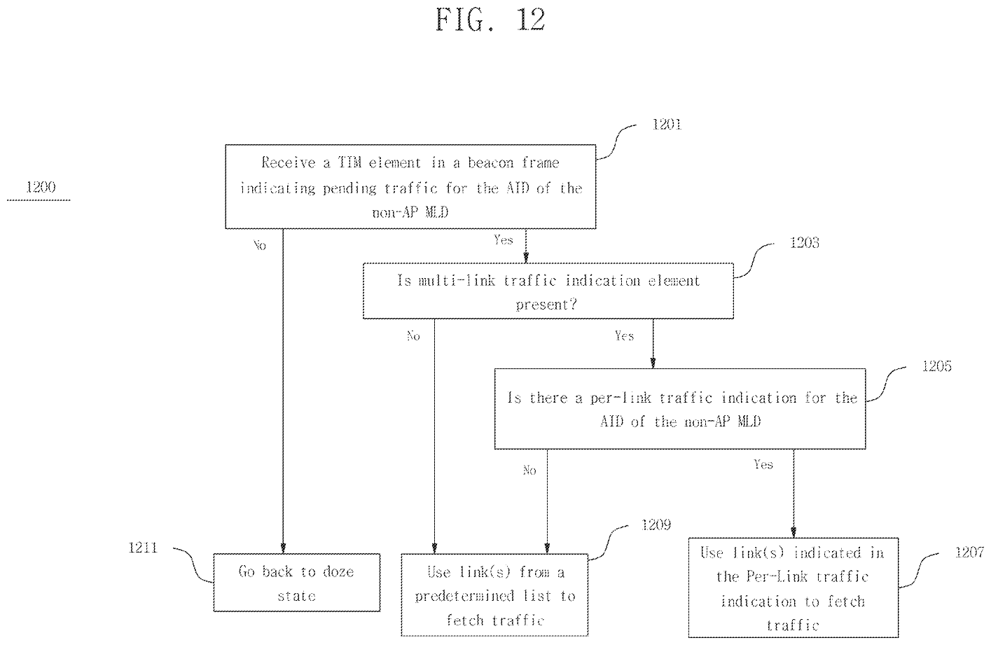

FIG. 12 shows an example of a process 1200 for receiving Multi-Link Traffic Indication element by non-AP MLD in accordance with an embodiment.

In operation 1201, the non-AP MLD detects that the non-AP MLD receives a TIM element in a Beacon frame that indicates pending buffered traffic for the AID of the non-AP MLD. The process 1200 proceeds to operation 1203 when the non-AP MLD receives the TIM element in the beacon frame. Otherwise, proceeds to operation 1211 and goes back to doze state.

In operation 1203, the non-AP MLD determines whether a Multi-Link Traffic Indication element is present in the beacon frame. The process 1200 proceeds to operation 1205 when the Multi-Link Traffic Indication element is present in the beacon frame. Otherwise, proceeds to operation 1209.

In operation 1205, the non-AP MLD determines whether there is a per-link traffic indication for the AID of the non-AP MLD. The per-link traffic indication may be present in a Per-Link Traffic Indication bitmap subfield within the Per-Link Traffic Indication List field of the Multi-Link Traffic Indication element. In one embodiment, the Multi-Link Traffic Indication element may include an optional field, for example, the optional field may be the Recommendation partial virtual bitmap field, the Recommendation partial virtual bitmap length field, the Recommendation bitmap present subfield, the Incremental AID List field, or the Traffic List format subfield. The Recommendation partial virtual bitmap field and the Incremental AID List field indicate the presence of recommendation link to the non-AP MLD. Therefore, the non-AP MLD can determine whether there is a per-link traffic indication for the AID of the non-AP MLD in the Per-Link Traffic Indication bitmap subfield based on the Recommendation partial virtual bitmap field and the Incremental AID List field. The process 1200 proceeds to operation 1207 when the per-link traffic indication for the AID of the non-AP MLD is present. Otherwise, proceeds to operation 1209.

In operation 1207, the non-AP MLD uses the links indicated in the Per-Link Traffic Indication List field of Multi-Link Traffic Indication element to fetch pending traffic at the AP MLD. An STA of the non-AP MLD operating on the link indicated in the Per-Link Traffic Indication List field can transmit a PS Poll frame or U-APSD trigger frame to retrieve buffered traffic from the AP MLD.

In operation 1209, the non-AP MLD uses a predetermined link list to fetch pending buffered traffic at the AP MLD by transmitting a PS Poll frame or U-APSD trigger frame to retrieve buffered traffic from the AP MLD.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) multi-link device (MLD) associated with a wireless network, the AP MLD comprising:
at least two APs affiliated with the AP MLD; and
a processor coupled to the at least two APs, the processor configured to:
generate a traffic indication map (TIM) element that indicates pending buffered traffic for a plurality of non-AP MLDs associated with the AP MLD,
selectively generate a multi-link traffic indication element that includes per-link traffic indication to retrieve buffered traffic for at least one non-AP MLD, based on determining whether all of the plurality of non-AP MLDs have default traffic identifier (TID)-to-link mapping and whether the AP MLD has buffered traffic with TIDs that are mapped to all enabled links for the at least one non-AP MLD,
generate the beacon frame including the TIM element and the multi-link traffic indication element that is selectively included, and
transmit the beacon frame to the plurality of non-AP MLDs.

2. The AP MLD of claim 1, wherein the processor is configured to generate the multi-link traffic indication element when at least one of the associated non-AP MLDs has successfully negotiated a TID-to-link mapping with the AP MLD and the AP MLD has buffered traffic with TIDs that are not mapped to all enabled links for the at least one non-AP MLD.

3. The AP MLD of claim 1, wherein the processor is configured to generate the multi-link traffic indication element when the AP MLD intends to provide a link recommendation to retrieve buffered traffic to the at least one non-AP MLD.

4. The AP MLD of claim 1, wherein the processor is configured to refrain from generating the multi-link traffic indication element when the AP MLD does not intend to provide a link recommendation to retrieve buffered traffic to any of the associated non-AP MLDs and when the AP MLD does not have buffered traffic with TIDs that are mapped to only a subset of enabled links for any of the associated non-AP MLDs.

5. The AP MLD of claim 1, wherein the multi-link traffic indication element includes a recommendation field that indicates the at least one non-AP MLD for which the AP MLD provides the per-link traffic indication to retrieve buffered traffic, wherein the per-link traffic indication includes a link recommendation or a traffic indication.

6. The AP MLD of claim 5, wherein the recommendation field includes a set of bits, each bit corresponding to a respective one of associated non-AP MLDs and non-AP stations (STAs), starting from an offset number of a traffic indication virtual bitmap in the TIM element, wherein the each bit indicates whether the AP MLD provides the per-link traffic indication for corresponding non-AP MLD or non-AP STA.

7. The AP MLD of claim 5, wherein the recommendation field includes a set of bits, each bit corresponding to a respective one of associated non-AP MLDs and non-AP STAs that are indicated to have buffered traffic in a traffic indication virtual bitmap of the TIM element, starting from an offset number of the traffic indication virtual bitmap in the TIM element, wherein the each bit indicates whether the AP MLD provides the per-link traffic indication for corresponding non-AP MLD or non-AP STA.

8. The AP MLD of claim 5, wherein the multi-link traffic indication element optionally includes the recommendation field, and the multi-link traffic indication element includes a recommendation present field that indicates whether the recommendation field is present in the multi-link traffic indication element.

9. The AP MLD of claim 5, wherein the multi-link traffic indication element includes one or more per-link traffic indication fields, each field providing a link recommendation or a traffic indication for a respective one of the at least one non-AP MLD.

10. The AP MLD of claim 1, wherein the multi-link traffic indication element is included in a group-addressed frame and not associated with the TIM element, including a recommendation field that indicates the at least one non-AP MLD for which the AP MLD provides the per-link traffic indication to retrieve buffered traffic.

11. A non-access point (AP) multi-link device (MLD) associated with a wireless network, the non-AP MLD comprising:
at least two stations (STAs) affiliated with the non-AP MLD; and
a processor coupled to the at least two STAs, the processor configured to:
receive, from an AP MLD associated with the non-AP MLD, a traffic indication map (TIM) element included in a beacon frame, the TIM element indicating pending buffered traffic for the non-AP MLD,
determine whether a multi-link traffic indication element is present in the beacon frame, wherein the multi-link traffic indication element is selectively included in the beacon frame based on whether all of the plurality of non-AP MLDs associated with the AP MLD have default traffic identifier (TID)-to-link mapping and whether the AP MLD has buffered traffic with TIDs that are mapped to all enabled links for the associated non-AP MLDs,
determine whether a per-link traffic indication for the non-AP MLD is present in the multi-link traffic indication element when the multi-link traffic indication element is present, the per-link traffic indication providing a traffic indication or a link recommendation to retrieve buffered traffic for the non-AP MLD,
transmit, to the AP MLD, a trigger frame to retrieve buffered traffic via a link indicated in the per-link traffic indication when the per-link traffic indication for the non-AP MLD is present, and
receive, from the AP MLD, buffered traffic via the link indicated in the per-link traffic indication.

12. The non-AP MLD of claim 11, wherein the multi-link traffic indication element is present in the beacon frame when at least one of the associated non-AP MLDs has successfully negotiated a TID-to-link mapping with the AP MLD and the AP MLD has buffered traffic with TIDs that are not mapped to all enabled links for the associated non-AP MLDs.

13. The non-AP MLD of claim 11, wherein the multi-link traffic element is present in the beacon frame when the AP MLD intends to provide a link recommendation to retrieve buffered traffic to at least one associated non-AP MLD.

14. The non-AP MLD of claim 11, wherein the multi-link traffic indication element is absent in the beacon frame when the AP MLD does not intend to provide a link recommendation to any of the associated non-AP MLDs and when the AP MLD does not have buffered traffic with TIDs that are mapped to only a subset of enabled links for any of the associated non-AP MLDs.

15. The non-AP MLD of claim 11, wherein the multi-link traffic indication element includes a recommendation field that indicates at least one non-AP MLD for which the AP MLD provides the per-link traffic indication, and
the processor is configured to determine whether the per-link traffic indication for the non-AP MLD is present in the multi-link traffic indication element, based on the recommendation field.

16. The non-AP MLD of claim 15, wherein the recommendation field includes a set of bits, each bit corresponding to a respective one of associated non-AP MLDs and non-AP stations (STAs), starting from an offset number of a traffic indication virtual bitmap in the TIM element, wherein the each bit indicates whether the AP MLD provides the per-link traffic indication for corresponding non-AP MLD or non-AP STA.

17. The non-AP MLD of claim 15, wherein the recommendation field includes a set of bits, each bit corresponding to a respective one of associated non-AP MLDs and non-AP STAs that are indicated to have buffered traffic in a traffic indication virtual bitmap in the TIM element, starting from an offset number of the traffic indication virtual bitmap in the TIM element, wherein the each bit indicates whether the AP MLD provides the per-link traffic indication for corresponding non-AP MLD or non-AP STA.

18. The non-AP MLD of claim 15, wherein the multi-link traffic indication element optionally includes the recommendation field, and the multi-link traffic indication element includes a recommendation present field that indicates whether the recommendation field is present in the multi-link traffic indication element, and
the processor is further configured to determine whether the multi-link traffic indication element includes the recommendation field, based on the recommendation present field.

19. The non-AP MLD of claim 15, wherein the multi-traffic indication element includes one or more per-link traffic indication fields, each field providing a link recommendation or a traffic indication for a respective one of the at least one non-AP MLD.

20. The non-AP MLD of claim 15, wherein the multi-link traffic indication element is included in a group-addressed frame and not associated with the TIM element, including a recommendation field that indicates at least one non-AP MLD for which the AP MLD provides the per-link traffic indication.
